(19) United States
(12) Patent Application Publication
(10) Pub. No.: US 2021/0187568 A1
(43) Pub. Date: Jun. 24, 2021

(54) MOBILE CLEANING UNIT FOR CLEANING BREATHING APPARATUS

(71) Applicant: MEIKO Maschinenbau GmbH & Co. KG, Offenburg (DE)

(72) Inventors: Herbert FALK, Offenburg (DE); Manuel PAULAT, Mühlenbach (DE); Marc SCHERER, Hofstetten (DE); Marijan SIMUNDIC, Ohlsbach (DE)

(21) Appl. No.: 16/762,496

(22) PCT Filed: Nov. 6, 2018
(86) PCT No.: PCT/EP2018/080281

§ 371 Date: May 7, 2020

(30) Foreign Application Priority Data
Nov. 7, 2017 (DE) 10 2017 219 763.3

(51) Int. Cl. B08B 9/032; B08B 5/02; B62B 5/06

(52) U.S. Cl. CPC B08B 9/0323; B62B 5/06; B08B 5/02; B08B 9/0328

(57) ABSTRACT

A mobile cleaning unit (410) for cleaning breathing apparatus (112) is proposed. The mobile cleaning unit (410) comprises:
at least one trolley (310) with at least one support surface (316) and with at least one running gear (320);
at least one pressurized-gas source (416) mounted on the trolley (310); and
at least one cleaning appliance (110) which is mounted on the trolley (310) and which serves for the cleaning of the breathing apparatus (112), wherein the cleaning appliance (110) comprises:
   at least one cleaning chamber (116) for accommodating at least one breathing apparatus (112),
   at least one fluid device (122) for applying at least one cleaning liquid to the breathing apparatus (112), wherein the fluid device (122) has at least one nozzle (124),
   at least one holder (174) which can be introduced into the cleaning chamber (116) and which serves for accommodating the breathing apparatus (112), wherein the holder (174) is configured to orient the breathing apparatus (112) relative to the fluid device (122),
   at least one pressure-applying appliance (202) which is connectable to the pressurized-gas source (416) and which has at least one pressure connector (204), wherein the pressure connector (204) is connectable to at least one gas-conducting element (196) of the breathing apparatus (112), wherein the pressure-applying appliance (202) is configured to charge the gas-conducting element with pressurized gas while the cleaning fluid is applied to the breathing apparatus.

### TECHNICAL FIELD

The invention relates to a mobile cleaning unit and to a method for cleaning and optionally additionally also for disinfecting breathing apparatus or constituent parts of breathing apparatus. Such appliances and methods may generally be used to clean breathing apparatus or constituent parts thereof, for example breathing apparatus for emergency services such as fire departments, technical aid organizations or emergency medical technicians, breathing apparatus for divers or generally persons in hostile or critical working environments and for armed forces and security forces such as for example police officers. The proposed appliances and methods can also be used for breathing apparatus in the medical sector, for example respiratory masks for oxygen supply and operations. In particular, as a field of use, consideration is given to the cleaning of respiratory masks or breathing regulators in general.

### TECHNICAL BACKGROUND

Breathing apparatus such as for example respiratory protection masks or breathing regulators are generally a constituent part of the personal protective equipment of, for example, emergency services, armed forces or security forces. A large number of breathing apparatus for different purposes are thus known from the prior art. For example, emergency services such as fire departments use respiratory protection masks with filters for removing harmful constituents from the drawn-in respiratory air. In many cases, however, as an alternative or in addition to a filter, use is made of a so-called breathing regulator by means of which the user can be ventilated with a respiratory gas, for example pressurized air. Breathing regulators generally enable a user to breathe from a pressurized-gas bottle or from some other pressurized-gas connection and thereby, for example, remain underwater or in some other atmosphere that cannot be breathed in or is toxic. For this purpose, the pressurized gas, for example compressed air, from the pressurized-gas connection is adapted by the breathing regulator to a pressure prevailing in a working environment of the user.

Breathing apparatus or constituent parts thereof must generally be cleaned, hygienized, dried, checked, repaired as necessary, and packaged after every use. All contamination resulting from use or storage must be removed by way of the cleaning process, such that the breathing apparatus can be provided in a macroscopically clean and hygienically satisfactory state, for example for the next steps of a preparation process. The same requirements generally also apply for other constituent parts of breathing apparatus, such as for example attachment and accessory parts of respiratory masks, such as for example filters or breathing regulators. Since breathing apparatus or the constituent parts thereof are generally safety-relevant appliances, numerous requirements have to be observed in the cleaning of these appliances. Aside from adequate cleaning and hygienization, it must for example be observed in many cases that accessory parts must remain assigned to the respective respiratory masks for technical reasons. Furthermore, there is generally the requirement that gas-conducting regions of particular elements of breathing apparatus, for example gas-conducting regions of breathing regulators, must not come into contact with cleaning fluid, for example must not come into contact with water and/or cleaning solution.

In many cases, breathing apparatus, such as for example respiratory masks and their accessories, are either cleaned by hand or washed in modified laundry washing machines with the aid of protective bags and/or with the aid of adapters. For example, EP 0 935 687 B1 generally discloses a washing machine which has a washing tub with a drum. A shell of the drum has a bulge structure directed toward the drum interior, wherein holes are arranged on edge contours, directed toward the drum exterior, of the bulge at the corner points thereof. With such washing machines, it is basically possible to realize particularly gentle cleaning of items of equipment for emergency services.

EP 1 088 928 A1 has disclosed a holding system for respiratory protection masks in a laundry treatment machine. The holding system has a carrying bracket which is arranged so as to co-rotate in a drum of the laundry treatment machine and to which the respiratory protection masks can be connected.

DE 200 03 743 U1 and DE 298 22 172 U1 have each disclosed appliances for the treatment of protective suits. Here, clothing hangers are used which comprise flexible air outlet nozzles. The clothing hangers are each fastened to a pivot device. Cleaning of breathing apparatus is generally not possible, or possible only with difficulty, by means of the appliances presented.

DE 10 2005 033 618 B3 has disclosed an appliance for cleaning respiratory protection masks. The appliance comprises a closable housing and at least one receptacle, which is arranged in a carrier, for at least one respiratory protection mask. Also provided are a nozzle arrangement and a brush arrangement, wherein brushing of the respiratory protection masks is realized by means of a movement of the respiratory protection masks. However, individual assignment and cleaning of accessory parts of masks is not possible by means of the disclosed appliance. Furthermore, the cleaning of gas-conducting elements, such as for example breathing regulators, is not possible with the disclosed appliance. Also, DE 200 03 744 U1 has disclosed an appliance for cleaning, disinfecting and drying respiratory protection masks, which appliance has a carrying frame with an assigned nozzle system and individual treatment locations. Said appliance is also basically not suitable for cleaning gas-conducting elements and accessory parts.

DE 10 2007 009 936 A1 has disclosed a cleaning appliance for compressed-air breathing appliances. Said cleaning appliance has an accommodating space, which is delimited by a protective grille, and has rotating nozzle carriers. Here, the nozzle carriers are situated outside the protective grille. A disadvantage of the illustrated appliance is however that cleaning liquid can ingress into gas-conducting regions.

By contrast, the cleaning of sensitive components of breathing apparatus, such as for example breathing regulators, is generally performed manually. If necessary, manual cleaning may be assisted by placement into ultrasound cleaning units. However, DE 10 2007 012 768 B4 has disclosed a method and an appliance for cleaning breathing regulators. Here, the articles for cleaning are mounted onto holders of a rotating element and are repeatedly dipped into a liquid bath with cleaning liquid, disinfection liquid and washing liquid. Breathing regulators are in this case firstly charged with pressurized air in order to establish a seal between valve and hose connection, and are thereafter dipped into the liquid bath. A disadvantage of such dipping methods is however that cumbersome holders with corresponding actuators are required in order to ensure, by means of corresponding movements, a removal of cleaning fluid from the various cavities after the cleaning process.

DE 100 20 835 A1 describes an appliance for the treatment of respiratory protection masks. A receptacle for populating with respiratory protection masks is provided, in the case of which the respiratory protection masks are coupled to the receptacle by means of the breathing apparatus connection. It is furthermore described that, in a cabin of the appliance, there is provided a collecting device for collecting treatment agents, along with a pump for the feed of the treatment agents.

U.S. Pat. No. 3,881,503 A discloses an appliance for washing and decontaminating articles of anesthetic equipment. A nozzle system is provided by means of which water jets can be sprayed at high pressure onto the articles for cleaning.

DE 11 74 169 B describes an appliance for cleaning respiratory protection masks. Here, in a housing, there is provided a rotatably mounted tubular frame, in the case of which the masks for cleaning are stretched over holders. By means of the rotary frame, the respiratory protection masks are moved through a bath of a cleaning liquid in a tub by way of a rotational movement.

WO 2011/144518 A2 describes a cleaning appliance for cleaning breathing apparatus. The cleaning appliance comprises at least one cleaning chamber for accommodating at least one breathing apparatus, and comprises at least one fluid device for applying at least one cleaning fluid to the breathing apparatus. The cleaning appliance furthermore has at least one pressure-applying appliance with at least one pressure connector. The pressure connector is connectable to at least one gas-conducting element of the breathing apparatus. The pressure-applying appliance is configured to charge the gas-conducting element with pressurized gas.

Despite the advantages achieved with the known methods and appliances for cleaning breathing apparatus, some technical challenges remain. For example, in particular relatively long deployments, such as for example large fires, pose technical and logistical challenges for emergency services. Since cleaning on site would be possible only manually, contaminated protective equipment is, in practice, collected on site and transported back to the operation center in order to be cleaned there. The emergency services must therefore be provided with substitute equipment on site, which increases the deployment costs and the logistical effort. In particular in the case of relatively large deployments and large distances to the operation center, or else to a correspondingly equipped respiratory protection workshop, the personal protective equipment is therefore often available only in limited quantities during the deployment. Furthermore, for example in the case of chemical accidents or other deployments involving hazardous substances, the transport of the contaminated personal protective equipment is associated with the risk of spreading the hazardous substances and contaminating additional surfaces or persons, which or who must then in turn likewise undergo a cleaning process.

### TECHNICAL OBJECTIVE

It would therefore be desirable to provide an appliance and a method which address the above-described problems in the context of personal protective equipment. In particular, it is sought to provide appliances and methods which simplify the logistics during large deployments and which prevent a risk of uncontrolled spreading of hazardous substances by the transport of personal protective equipment.

### DISCLOSURE OF THE INVENTION

Accordingly, a mobile cleaning unit and a method for cleaning breathing apparatus are proposed, having the features of the independent patent claims. Advantageous refinements, which may be realized individually or in any desired combination evident to a person skilled in the art, are presented in the dependent claims.

Below, the expressions “exhibit”, “have”, “comprise” or “include” or any grammatical variants thereof are used in a non-exclusive sense. Accordingly, such expressions may refer both to situations in which no further features are provided in addition to the features introduced by such expressions, or to situations in which one or more further features are provided. For example, the expression “A exhibits B”, “A has B”, “A comprises B” or “A includes B” may refer both to the situation in which no further element aside from B is provided in A (that is to say to a situation in which A is composed exclusively of B) and to the situation in which, in addition to B, one or more further elements are provided in A, for example element C, elements C and D, or even further elements.

It is furthermore pointed out that the expressions “at least one” and “one or more” and grammatical variants of such expressions, where used in conjunction with one or more elements or features and intended to express that the element or feature may be provided singly or multiply, are generally used only once, for example when the feature or element is introduced for the first time. When the feature or element is mentioned again later, the corresponding expression “at least one” or “one or more” will generally no longer be used, without restriction of the possibility that the feature or element may be provided singly or multiply.

Furthermore, below, the expressions “preferably”, “in particular”, “for example” or similar expressions are used in conjunction with optional features, without alternative embodiments hereby being restricted. Accordingly, features introduced by such expressions are optional features, and it is not intended to restrict the scope of protection of the claims, and in particular of the independent claims, by means of such features. Accordingly, as a person skilled in the art will identify, the invention may also be implemented using other refinements. Similarly, features introduced by “in one embodiment of the invention” or “in one exemplary embodiment of the invention” are to be understood to be optional features, without this being intended to restrict alternative refinements or the scope of protection of the independent claims. Furthermore, it is the intention that all possibilities of combining the features hereby introduced with other features, whether these be optional or non-optional features, remain unaffected by such introductory expressions.

In a first aspect, a mobile cleaning unit for cleaning and optionally also for disinfecting breathing apparatus is proposed. The mobile cleaning unit comprises:
at least one trolley with at least one support surface and with at least one running gear;
at least one pressurized-gas source mounted on the trolley, in particular a pressurized-air source; and
at least one cleaning appliance which is mounted on the trolley and which serves for the cleaning of the breathing apparatus, wherein the cleaning appliance comprises:
   at least one cleaning chamber for accommodating at least one breathing apparatus,
   at least one fluid device for applying at least one cleaning liquid to the breathing apparatus, wherein the fluid device has at least one nozzle,
   at least one holder which can be introduced into the cleaning chamber and which serves for accommodating the breathing apparatus, wherein the holder is configured to orient the breathing apparatus relative to the fluid device,
   at least one pressure-applying appliance which is connectable to the pressurized-gas source and which has at least one pressure connector, wherein the pressure connector is connectable to at least one gas-conducting element of the breathing apparatus, wherein the pressure-applying appliance is configured to charge the gas-conducting element with pressurized gas while the cleaning fluid is applied to the breathing apparatus.

The expression “breathing apparatus” as it is used here is a broad expression which is to be attributed its usual and common meaning as it is understood by a person skilled in the art. The expression is not restricted to a specific or adapted meaning. The expression may, without limitation, refer in particular to appliances which are configured in any way for providing respiratory gas to at least one human and/or animal user. These breathing apparatus may be complete, operationally ready breathing apparatus, or else may be constituent parts thereof, such that, below, no distinction is made in terms of terminology between breathing apparatus and the constituent parts thereof. In particular, the breathing apparatus may comprise respiratory masks, respiratory protection masks, hoses, valves, filters, pressurized-gas vessels, breathing regulators or combinations of the stated elements and/or other elements.

The expression “to clean” as it is used here is likewise a broad expression which is to be attributed its usual and common meaning as it is understood by a person skilled in the art. The expression is not restricted to a specific or adapted meaning. The expression may, without limitation, refer in particular to a removal of adherent dirt or other contaminants from material for cleaning or from articles for cleaning and optionally also to a germ-reducing and/or germicidal action or even a disinfecting action.

The expression “cleaning unit” as it is used here is likewise a broad expression which is to be attributed its usual and common meaning as it is understood by a person skilled in the art. The expression is not restricted to a specific or adapted meaning. The expression may, without limitation, refer in particular to a unit, that is to say to an appliance or group of appliances which are handleable as a whole or collectively, which is configured for the cleaning of articles for cleaning. A “mobile cleaning unit” may accordingly be understood to mean a cleaning unit which is mobile, in particular such that it can be moved, for example can be rolled, from one location to another by a single person or two persons in a comfortable manner and preferably without the use of transport aids such as forklift trucks or pallet trucks.

The expression “trolley” as it is used here is likewise a broad expression which is to be attributed its usual and common meaning as it is understood by a person skilled in the art. The expression is not restricted to a specific or adapted meaning. The expression may, without limitation, refer in particular to a mobile accommodating appliance, in particular a rollable accommodating appliance, for accommodating one or more articles in at least one interior space and/or on at least one support surface. In particular, the trolley may be configured as a roller trolley and/or as a roller container. The trolley accordingly has at least one support surface, that is to say a surface on which material for transport can be accommodated. The support surface may in particular be of at least partially planar form and may for example be a surface of at least one support plate or base plate, which may be produced for example from plastic, wood material, wood or metal. The trolley may accordingly furthermore have a running gear, that is to say an appliance by means of which the trolley can be rolled, that is to say for example one or more rollers, wheels, rolls or balls. In particular, the roller trolley may for example have three or four wheels, of which, for example, one wheel or two wheels may also be configured such that they can turn. Furthermore, the running gear may have at least one immobilizing brake by means of which, for example, the wheels or the running gear can be blocked. The roller trolley may be equipped with an appliance, for example a hoop-like handle, which makes it possible or easier for said roller trolley to be pushed by hand.

The expression “pressurized gas” as it is used here is likewise a broad expression which is to be attributed its usual and common meaning as it is understood by a person skilled in the art. The expression is not restricted to a specific or adapted meaning. The expression may, without limitation, refer in particular to any gas which has a pressure above the normal pressure, that is to say a pressure above 1 bar. In particular, this may be a pressure above 1.5 bar, in particular above 2 bar, and particularly preferably above 3 bar. In particular, the pressurized gas may be pressurized air, also referred to as compressed air.

Accordingly, the expression “pressurized-gas source” as it is used here is a broad expression which is to be attributed its usual and common meaning as it is understood by a person skilled in the art. The expression is not restricted to a specific or adapted meaning. The expression may, without limitation, refer in particular to a source for providing pressurized gas within the meaning of the definition above, for example pressurized air. The pressurized-gas source may accordingly in particular be a pressurized-air source, or the pressurized-gas source may comprise at least one pressurized-air source. The pressurized-gas source may in particular comprise an appliance for storing pressurized gas, for example at least one pressurized-gas bottle, and/or at least one appliance for compressing gas, in particular a compressor. Alternatively or in addition, the pressurized-gas source may however also have at least one external pressure connector for the connection of at least one external pressurized-gas source, for example of an on-site pressurized-gas line, of an external compressor or of an external pressurized-gas bottle.

The pressurized-gas source is mounted on the trolley. In general, in this context or else in other contexts, the expression “mounted on the trolley” is to be understood as having the meaning attributed to said expression by a person skilled in the art. The expression is not restricted to a specific or adapted meaning. The expression may, without limitation, refer in particular to any positionally fixed accommodation of at least one article in or on the trolley. Here, the article mounted on the trolley may for example be connected, for example detachably connected, to the trolley by means of at least one fixing device, for example by means of at least one fixing strap, at least one screw connection, at least one clamp, at least one non-positively locking fixing device, at least one positively locking fixing device or by means of a combination of two or more of these fixing devices. Furthermore, the trolley may also have at least one receptacle in which the article for mounting is accommodated, for example at least one compartment for accommodating the article, for example a closable partition, rack compartment or container compartment.

Furthermore, as stated above, at least one cleaning appliance for cleaning the breathing apparatus is mounted on the trolley. Here, a “cleaning appliance” is basically to be understood as having the meaning attributed to said expression by a person skilled in the art. The expression is not restricted to a specific or adapted meaning. The expression may, without limitation, refer in particular to any appliance which is configured to clean at least one article for cleaning within the meaning of the definition above.

The cleaning appliance comprises at least one cleaning chamber for accommodating at least one breathing apparatus. The expression “cleaning chamber” as it is used here is a broad expression which is to be attributed its usual and common meaning as it is understood by a person skilled in the art. The expression is not restricted to a specific or adapted meaning. The expression may, without limitation, refer in particular to a space which is partially or completely enclosed by at least one wall or at least one housing and in which cleaning within the meaning of the definition above can be performed. Said cleaning chamber may basically be configured as a cleaning chamber which is closed, opened or provided for being opened. It is particularly preferable if the cleaning chamber is enclosed on all sides, or at least in two dimensions, by a housing which may be of completely closed design, but which may basically also have one or more leadthroughs and/or openings. The cleaning chamber may in particular be configured as a rigid cleaning chamber, that is to say as a cleaning chamber which does not change its position and/or orientation during a cleaning process, though may basically also be designed as a movable cleaning chamber, for example as a pivotable and/or rotatable cleaning chamber, which changes its position and/or orientation during a cleaning process in the cleaning appliance, for example by means of a turning movement, a rotation, a spinning process, a vibrating process or similar movements. In this respect, the cleaning chamber may for example be designed as a washing chamber of a washer, and the cleaning appliance may be designed as a washer, and/or the cleaning chamber may be designed as a drum of a washing machine, and the cleaning appliance may be in the form of a washing machine. For example, dishwashers and/or laundry washing machines of commercial type or for the domestic sector may be modified in accordance with the invention. In particular, however, use may be made of a modified washer such as is commonly utilized for industrial applications, in particular a single-chamber washer with exactly one cleaning chamber, the fluid device of which has two separate systems, specifically a washing system and a separate rinsing system with a separate rinsing tank, in which rinsing fluid can be temperature-controlled already during the washing process.

The cleaning appliance furthermore has at least one fluid device for applying at least one cleaning fluid to the breathing apparatus. Here, a “cleaning fluid” may be understood generally as having the usual and common meaning attributed to said expression by a person skilled in the art. In particular, said expression may be understood to mean basically any liquid which is suitable for cleaning the article for cleaning, in this case in particular the breathing apparatus. In particular, it may be an aqueous liquid, for example water with or without added active washing substances, for example detergents, rinsing aids or the like. Here, as stated above, one or two or even more cleaning fluids may be used in the cleaning appliance, for example a washing liquid and a rinsing liquid. It is thus possible, for example, for the washing liquid to be water with one or more added cleaner concentrates, and, as rinsing fluid, use may for example be made of fresh water with or without added rinsing aids.

The expression “fluid device” as it is used here is a broad expression which is to be attributed its usual and common meaning as it is understood by a person skilled in the art. The expression is not restricted to a specific or adapted meaning. The expression may, without limitation, refer in particular to an appliance by means of which the cleaning fluid can be applied directly or indirectly in any way to the breathing apparatus accommodated within the cleaning chamber. This application is performed for example in the form of a direct application, by application in spray form, application in droplet form, application in jet form or a combination of the stated and/or other types of direct application, in the case of which cleaning fluid emerging from the fluid device impinges in particular directly on the breathing apparatus. This form of the application may be performed in particular in the case of a fixed cleaning chamber, for example in the case of a washer. Alternatively or in addition, the application by means of the fluid device may also be performed such that the fluid device completely or partially fills the cleaning chamber with cleaning fluid, such that the cleaning fluid accommodated in the cleaning chamber comes into contact with the cleaning fluid at least in one position of the cleaning chamber. This form of the application may be utilized in particular in the case of the cleaning chamber being embodied as a movable cleaning chamber, for example in the form of a drum. Combinations of the stated types of application and/or other types of application are also possible. Irrespective of whether the cleaning chamber is of rigid or movable design, the application of the cleaning fluid may be performed in a simple operating mode by virtue of the cleaning fluid impinging on the breathing apparatus only once. Alternatively or in addition, cleaning may however also be performed in a circulation operating mode by virtue of cleaning fluid being applied to the breathing apparatus multiple times. Such circulation operating modes and circulation circuits are known for example from conventional washers or washing machines. In particular, it is also possible for a combined operating mode to be implemented in a cleaning program, in which the breathing apparatus is washed with at least one washing liquid once or several times in the circulation operating mode, followed by at least one rinsing step, in which a rinsing liquid is applied to the breathing apparatus once, without circulation of the cleaning fluid. Subsequently, at least one drying step may be performed. The cleaning appliance may in particular be designed as an automatic programmed unit and may have a controller which is configured to carry out at least one cleaning program.

The fluid device has at least one nozzle. The expression “nozzle” as it is used here is a broad expression which is to be attributed its usual and common meaning as it is understood by a person skilled in the art. The expression is not restricted to a specific or adapted meaning. The expression may, without limitation, refer in particular to an appliance in which a fluid is fed by means of a feed device to an opening and can emerge from said opening, for example in one or more droplets or jets. The nozzle may in particular be accommodated in one or more nozzle arms within the cleaning chamber, for example in one or more rotatable nozzle arms. For example, the cleaning appliance may have one or more nozzle arms above the holder for the breathing apparatus, and may have one or more nozzle arms below the holder for the breathing apparatus. As stated above, a separate nozzle system for a washing process in the circulation operating mode and a nozzle system for a rinsing process can be provided, wherein the rinsing nozzle system may for example be fed directly from a separate rinsing tank, whereas the washing nozzle system is fed from a tank situated on the base of the cleaning chamber. Other embodiments are however also possible.

The cleaning appliance has at least one holder which can be introduced into the cleaning chamber and which serves for accommodating the breathing apparatus. The expression “holder” as it is used here is a broad expression which is to be attributed its usual and common meaning as it is understood by a person skilled in the art. The expression is not restricted to a specific or adapted meaning. The expression may, without limitation, refer in particular to an appliance which is configured to accommodate one or more elements and to mount or hold these in a positionally fixed manner and in particular in a certain orientation. In particular, the holder may have at least one basket. The holder may be installed fixedly in the cleaning chamber, though may also be designed to be movable and/or may be designed as a removable holder, which can be removed from the cleaning chamber, preferably without an additional tool being necessary for this purpose. In particular, the holder may have at least one basket which is removable from the cleaning chamber. The holder is configured to orient and preferably to fix the breathing apparatus relative to the fluid device. For example, this fixing may be performed such that cleaning fluid is duly applied to the breathing apparatus at critical locations, but the cleaning fluid, after being applied, can preferably flow off from said critical regions, for example out of concave bulges of respiratory masks. The holder may also be designed to be pivotable, such that different positions can be assumed during different steps of a cleaning process.

For example, at least one first position may be provided for an application of the cleaning fluid, and at least one second position may be provided for an emptying of the breathing apparatus. The at least one first position may also change during the program, such that application can be performed from multiple directions without the fluid device, for example the nozzles, having to be varied in terms of their position and/or orientation for this purpose, though this may equally be performed. Emptying may be performed for example by tilting and/or rotation of the holder, such that, for example, respiratory masks and/or interior regions of hoses can be emptied. Alternatively or in addition to a holder for fixing the breathing apparatus, it is however basically possible for the breathing apparatus to be accommodated in a non-oriented and/or non-fixed manner in the cleaning chamber.

In general, the cleaning appliance may accordingly be a modified dishwasher and/or a modified laundry washing machine or may comprise such a dishwasher or laundry washing machine in a modified state. It is particularly preferable if the cleaning appliance is configured such that the application of cleaning fluid is performed by application in jet form, application in spray form or application in droplet form. In particular, it is the intention that the breathing apparatus is not dipped, or is at least not fully dipped, into the cleaning fluid during the application process, such that the cleaning fluid, directly upon or directly after the impingement on the breathing apparatus, can flow off or drip off said breathing apparatus again. In this way, it is possible to prevent the cleaning fluid from ingressing into the gas-conducting element as a result of a relatively long period of action or even as a result of application of cleaning fluid at positive pressure to the breathing apparatus, and/or it is possible to prevent residues of the cleaning fluid from remaining in the breathing apparatus. For example, this is ensured if the cleaning appliance is designed as a washer in which the breathing apparatus is accommodated in a holder and cleaning fluid is applied thereto from at least one nozzle, for example from above and/or from below the holder, wherein, after the application process, the cleaning fluid can flow and/or drip directly off the breathing apparatus into a washing tank.

The holder may in particular be designed such that it has multiple different receptacles which are configured for accommodating different types of breathing apparatus and/or different constituent parts of the breathing apparatus. In particular, the holder may comprise multiple compartments and/or receptacles in which different constituent parts of a breathing apparatus can be accommodated and possibly fixed and/or spatially oriented, wherein the constituent parts nevertheless remain assigned to one another, such that, after the cleaning process, the constituent parts can again be assigned to one another and joined together without being mixed up. For example, the holder may thus comprise at least two holder groups each with a multiplicity of receptacles, wherein in each case one holder group is assigned one breathing apparatus, and wherein in each case one holder group comprises multiple different types of receptacles for accommodating different constituent parts of a breathing apparatus.

The cleaning appliance furthermore has at least one pressure-applying appliance which is connectable to the pressurized-gas source and which has at least one pressure connector. The expression “pressure-applying appliance” as it is used here is a broad expression which is to be attributed its usual and common meaning as it is understood by a person skilled in the art. The expression is not restricted to a specific or adapted meaning. The expression may, without limitation, refer in particular to an appliance which is provided on the cleaning appliance and which is configured to provide pressurized gas on the cleaning appliance. In particular, the pressure-applying appliance may comprise, on the cleaning appliance, at least one pressurized-gas fitting and/or at least one pressurized-gas valve which is connectable on the one hand to the pressurized-gas source and on the other hand to the pressure connector. For example, the pressure-applying appliance may be a component of the cleaning appliance, which component is for example controllable by means of a controller of the cleaning appliance such that, for example by means of at least one valve, it is correspondingly possible in one or more program steps for pressurized gas of the pressurized-gas source to be provided at the pressure connector. The gas pressure provided by the pressurized-gas source may in this case be transmitted onward without being reduced or throttled. The pressure-applying appliance may for example have a fitting for direct or indirect connection to the pressurized-gas source, for example a threaded fitting and/or a fitting with a quick-action fastener. The pressure-applying appliance furthermore has the at least one pressure connector for connecting to the at least one gas-conducting element of the breathing apparatus. The expression “pressure connector” is to be attributed the usual meaning attributed to said expression by a person skilled in the art. In particular, a pressure connector may basically be understood to mean any connection of the pressure-applying appliance via which the pressurized gas of the pressure-applying appliance can be provided. In particular, said pressure connector may be arranged in the interior of the cleaning chamber and/or may be accessible from the interior of the cleaning chamber. A provision of a multiplicity of pressure connectors is also conceivable. The pressure connector should be connectable to at least one gas-conducting element of the breathing apparatus in the cleaning chamber, preferably to multiple gas-conducting elements of multiple breathing apparatus in the cleaning chamber. The expression “gas-conducting element” is in this case a broad expression which is to be attributed the usual meaning as understood by a person skilled in the art. In general, said expression may be understood to mean an element which, during use of the breathing apparatus by a human or animal user, is charged with a respiratory gas or may come into contact with the respiratory gas in some other way. In particular, it may here be a breathing regulator and/or a breathing hose with at least one valve. In particular, the gas-conducting element may be an element which has at least one hose and/or at least one other type of gas-conducting appliance with an interior space and/or at least one valve which generally must not have cleaning fluid applied thereto. For example, the gas-conducting element may be a region of the breathing apparatus which, during operation, is charged with a pressure above the normal pressure, for example a gas-conducting region of a breathing apparatus above a normal pressure, for example above 1.5 bar, in particular above 2 bar. In particular, it may be a respiratory-gas-conducting region of a breathing regulator, wherein the breathing regulator may basically be a single-stage or else a multi-stage breathing regulator. Here, the gas-conducting element may for example be a part of a first stage and/or of a second stage and/or possibly of further stages of the breathing regulator, or else may be a complete breathing regulator. For example, the gas-conducting element may be a region between a hose connection and a valve of a breathing regulator, or the gas-conducting element may comprise such a region.

A connection between the pressure connector and the gas-conducting element may be understood in particular to mean a fluidic connection, in particular a gas connection, such that the pressurized gas of the pressure-applying appliance can be transferred into the gas-conducting element of the breathing apparatus, in particular into an interior space of the gas-conducting element, preferably without leakage and/or a pressure loss occurring at said connection. Furthermore, the connection between the pressure connector and the gas-conducting element of the breathing apparatus may optionally comprise at least one mechanical connection, in particular a positively locking and/or non-positively locking connection, such that the breathing apparatus can be fixedly connected to the pressure connector. For example, this may involve a screw connection and/or a clamping connection and/or a bracing connection, for which purpose the pressure connector and/or the breathing apparatus may each have at least one mechanical connecting element. In particular, use may be made here of a plug-type connection in the form of a quick-action coupling and/or a thread, for example a coupling piece for a respiration connector of a breathing regulator. A quick-action coupling is to be understood here generally to mean a gas-tight and/or a liquid-tight plug-type connection between two fluid-conducting components, which plug-type connection can be mechanically secured by means of a mechanical fixing which can be produced and released easily and quickly, in particular without the use of a screw fastener, for example by means of at least one bracing hook and/or a bayonet fastener and/or a screw fastener, for example a sleeve nut. The connection may in particular be producible without the use of tools.

In particular, the pressure connector may comprise a multiplicity of adapters, which are designed to be fixed or exchangeable, for connection to different types of gas-conducting elements. By means of these adapters, it is possible for a multiplicity of different gas-conducting elements to be connectable directly or indirectly to the pressure connector, for example different types and/or different forms of gas-conducting elements, for example from different factories or manufacturers. For example, an adapter set may be provided which has a multiplicity of different coupling pieces (for example coupling pieces of a quick-action coupling) and/or threads for the connection of different gas-conducting elements. For example, this may involve different quick-action coupling systems and/or standardized threads. Alternatively or in addition, the at least one pressure connector may however also be designed as a fixed pressure connector for a particular type of connecting element or for a particular type of gas-conducting element. It is particularly advantageous if the pressure connector and/or the coupling system are configured such that, firstly, no gas can escape when no counterpart is connected, and such that, in this case, it is also not possible for any other medium, for example cleaning fluid, to ingress into the gas-conducting element.

The pressure-applying appliance is configured to charge the gas-conducting element with pressurized gas while the cleaning fluid is applied. The pressure-applying appliance is particularly preferably configured such that the application of pressure with the pressurized gas is performed such that all cleaning fluid is kept out of an interior space, charged with the pressurized gas, of the breathing apparatus. The cleaning appliance may in particular be designed such that the application of pressure by means of the pressure-applying appliance takes place during at least one cleaning program, for example during at least one program step of a single-step or multi-step cleaning program. In particular, the charging with the pressurized gas may be performed at the same time as the application of the cleaning fluid to the breathing apparatus. The pressure connector may accordingly be arranged in particular within the cleaning chamber such that the simultaneous charging with pressurized gas and application of cleaning fluid can be performed.

As stated above, the pressure-applying appliance is connectable, in particular connected, to the pressurized-gas source. This connection may be designed to be permanent or else releasable. The connection may for example be produced by means of at least one pressurized-gas hose. For example, said at least one pressurized-gas hose may be provided between at least one pressurized-gas bottle and/or at least one compressor of the pressurized-gas source and the pressure-applying appliance. The pressurized-gas hose may for example have, at both ends, corresponding connecting elements, in particular corresponding threads and/or quick-action fasteners.

The trolley may in particular have at least one push frame with at least one handle, in particular with a push bar. The trolley may thus for example have a horizontally extending support surface and a push frame which extends vertically upward at one end of the support surface, for example with a horizontal transverse bar as a handle. The handle may in particular be equipped with a brake, for example a brake which can act directly or indirectly on the running gear. In particular, the handle may have at least one dead man's brake, that is to say a brake which is automatically actuated when a user releases the handle.

It is furthermore advantageous if the mobile cleaning unit permits blow-drying of the breathing apparatus using pressurized gas. Accordingly, the mobile cleaning unit may for example furthermore have at least one pressurized-gas pistol which is connectable, in particular connected, to the pressurized-gas source and which serves for blow-drying the breathing apparatus, in particular a pressurized-air pistol. This may for example be handleable in a mobile manner by means of a pressurized-gas hose, and can for example be hooked onto a holder of the mobile cleaning unit when the pressurized-gas pistol is not required.

The pressurized-gas source may in particular comprise at least one element selected from the following group: a pressurized-gas bottle; a compressor; a pressurized-gas fitting for the connection of an external pressure source. The pressurized-gas source may, as stated above, be mounted in particular in detachable fashion on the trolley, for example by means of corresponding receptacles and/or fixing elements such as for example one or more compartments and/or tension straps.

The mobile cleaning unit may furthermore comprise at least one waste water tank mounted on the trolley. The waste water tank may basically be any tank, for example a container produced from high-grade steel and/or plastic and serving for liquids, having at least one opening, which is preferably closable. The waste water tank can for example accommodate a quantity of waste water sufficient for at least one cleaning process, for example at least 5 l or at least 10 l. The waste water tank may in particular be connected to at least one drain of the cleaning appliance. The waste water tank may in particular be mounted detachably on the trolley, for example by means of at least one fixing element and/or by means of at least one accommodating compartment for accommodating the waste water tank. The waste water tank may furthermore have at least one drain opening for the disposal of the liquids situated therein. Between the waste water tank and the drain of the cleaning appliance, there may for example be a permanent or else a detachable connection, for example a hose connection.

The mobile cleaning unit may furthermore have at least one fresh water treatment system which is mounted on the trolley and which serves for the treatment of fresh water. The fresh water treatment system may in particular be connected directly or indirectly to at least one feed of the cleaning appliance. For example, on site during a deployment, it may thus be necessary for fresh water of low quality to initially be filtered and/or completely or partially freed of particular contaminants and/or salts. A “fresh water treatment system” may accordingly be understood generally as having the meaning attributed to said expression by a person skilled in the art. In particular, the fresh water treatment system may be or comprise an appliance which is configured to remove at least one unwanted component and/or contaminant from fed fresh water. In particular, the fresh water treatment system may comprise at least one appliance selected from the following group: a reverse osmosis system; an ion exchanger; a fresh water filter.

It may correspondingly also be necessary for waste water to be disposed of on site, wherein it should be ensured that no contaminants pass from the cleaning appliance into the environment and the groundwater if pollutants are to be expected in the context of the deployment. The above-described waste water tank constitutes one possibility for this purpose, though the transport of waste water to a disposal site may be correspondingly associated with logistical effort. Alternatively or in addition to a waste water tank, the mobile cleaning unit may correspondingly furthermore have at least one waste water treatment system mounted on the trolley. A “waste water treatment system” may accordingly be understood generally as having the meaning attributed to said expression by a person skilled in the art. In particular, the waste water treatment system may be or comprise an appliance which removes at least one undesired constituent from the waste water. Accordingly, the waste water treatment system may for example comprise at least one element selected from the group comprising a filter and a reverse osmosis system. Other embodiments are also possible. The waste water treatment system may be connectable, in particular connected, to the at least one drain of the cleaning appliance. If both a waste water tank and a waste water treatment system are provided, then it is for example possible for a switchable valve to be provided, by means of which a selection can be made as to whether waste water is disposed of from the drain into the waste water treatment system or into the waste water tank. A combination is also possible.

Furthermore, during a deployment, fresh water is not always available in sufficient quantity and/or quality. Accordingly, the mobile cleaning unit may for example also comprise at least one fresh water tank mounted on the trolley. The fresh water tank may basically have any container, for example produced from plastic and/or metal, in particular high-grade steel, for accommodating a sufficient quantity of fresh water for at least one cleaning process, for example a quantity of at least 5 l or in particular at least 10 l. The fresh water tank may be connectable, in particular connected, to at least one feed of the cleaning appliance. In turn, it is for example possible for at least one switchable valve to be provided, by means of which it is possible to select, automatically or manually, whether fresh water from an external fresh water source, possibly after treatment by means of the fresh water treatment system, or from the fresh water tank is provided to the cleaning appliance. The fresh water tank may also be used in combination with other elements, for example in combination with a fresh water treatment system, which may for example likewise be included in the mobile cleaning unit. Alternatively, the fresh water tank may however also be connected directly to the cleaning appliance.

As already stated above, the trolley may for example have one or more compartments for accommodating elements of the mobile cleaning unit and/or for accommodating accessories. Accordingly, the mobile cleaning unit may for example have at least one cabinet element which is mounted on the trolley and which serves for accommodating cleaning utensils. Furthermore, the cabinet element may for example also be configured to accommodate one or more of the elements stated above, for example one or more of the elements selected from the following group: the waste water tank, the fresh water tank, the fresh water treatment system, the waste water treatment system, the pressurized-gas source, a power unit, a battery. The compartments may for example be closable by means of corresponding doors, or else may be designed merely as open racks, wherein, in the latter case, fixing for the elements accommodated therein is preferably provided in some other way, for example by means of corresponding tension straps or similar fixing elements.

The mobile cleaning unit may furthermore have at least one work surface mounted on the trolley. For example, said work surface may be provided or formed by at least one surface of the at least one cabinet element. In particular, the work surface may be produced from resistant material, for example high-grade steel.

Furthermore, during a deployment, there is not always a corresponding power source available for the operation of the cleaning appliance and/or of other components of the mobile cleaning unit. Accordingly, the mobile cleaning unit may furthermore have at least one power unit mounted on the trolley. For example, this may be a fuel-powered generator. This may also be accommodated or capable of being accommodated for example in at least one compartment of the trolley, for example of the roller container, or may also be arranged separately. Furthermore, the mobile cleaning unit may also have, for example, at least one power distributor which may be connectable for example to an external connection and which can provide corresponding power connections for components of the mobile cleaning unit, for example the cleaning appliance and/or further components. Here, it is for example also possible for a power transformation to be performed, such that the mobile cleaning unit may also for example comprise at least one transformer and/or at least one power converter, for example.

The mobile cleaning unit may furthermore also have at least one waste water lifting system. The expression “waste water lifting system” as it is used here is a broad expression which is to be attributed its usual and common meaning as it is understood by a person skilled in the art. The expression is not restricted to a specific or adapted meaning. The expression may, without limitation, refer in particular to a system which is configured to discharge waste water, which accumulates below a backwash level, without backwash, and/or to lift waste water to a higher level, in particular by pumping. The waste water lifting system may in particular operate automatically. The waste water lifting system may be connected fixedly or detachably to the trolley.

The mobile cleaning unit may furthermore comprise at least one fresh water connection, for example at least one feed fitting, which can supply fresh water to one or more consumers of the mobile cleaning unit, in particular the cleaning appliance. The feed fitting may for example have at least one corresponding thread. The feed fitting may for example also have at least one distributor in order to provide a supply to multiple consumers, for example via one or more valves.

The mobile cleaning unit may furthermore comprise at least one waste water connection mounted on the trolley, wherein the waste water connection is connected to at least one drain of the cleaning appliance. The waste water connection may for example be designed to be connectable to at least one external drain.

The mobile cleaning unit may furthermore have at least one washbasin mounted on the trolley. In particular, said washbasin may be integrated into a work surface. The washbasin and/or the mobile cleaning unit may furthermore have at least one hand shower mounted on the trolley, in particular an extendable hand shower.

The mobile cleaning unit may in particular be designed such that it can be stacked and/or arranged in a standardized manner. For example, this may be advantageous for transport in an implement truck and/or in a transport container. Accordingly, the trolley may for example have a basic dimension of a standardized transport pallet, in particular a basic dimension selected from: 800 mm×600 mm; 1200 mm×800 mm; 1200 mm×1000 mm; 1200 mm×900 mm; 1140 mm×1140 mm Multiples of a basic dimension, or other standardized dimensions, are however basically also possible.

The application of the at least one cleaning liquid to the breathing apparatus in the cleaning appliance may be performed in particular in the form of a direct application, wherein cleaning fluid emerging from the fluid device impinges directly on the breathing apparatus. The application may in this case be selected in particular from application in spray form, application in droplet form, application in jet form or a combination of the stated types of application.

As stated above, the pressure connector may in particular comprise a connecting element. The connecting element may, aside from a pressure connection, furthermore also be configured for additionally producing at least one mechanical connection to the breathing apparatus. The connecting element may in particular be selected from the group comprising a positively locking connecting element and a non-positively locking connecting element. The pressure connector may in particular have a multiplicity of different adapters for connecting to different types of gas-conducting elements.

The holder may in particular be a removable holder. The pressure connector may in particular be at least partially integrated into the holder. This integration may be realized for example in rigid or else flexible form. Accordingly, the pressure connector may for example be connected rigidly to the holder, or else may be connected for example in the form of a hose to the holder. The hose may for example have a free fitting which lies for example in the holder, such that, for example, a breathing regulator can also be connected to a coupling lying loosely in the holder, for example a basket. The holder may in particular have a detachable pressurized-gas connection to the rest of the cleaning appliance. For example, at least one hose connection may thus be provided in order to connect the holder to at least one pressure fitting and/or to another element of the pressure-applying appliance which is for example integrated fixedly in the interior of the cleaning chamber. For example, the holder may comprise a cage which is removable from the cleaning chamber, wherein the pressure connector is integrated into the holder and is connected to other constituent parts of the pressure-applying appliance, which are integrated fixedly in the cleaning chamber, by means of at least one pressurized-gas hose. If the cage is inserted into the cleaning chamber, the connection is closed, and conversely, if the cage is removed from the cleaning chamber, the connection is opened. For example, the pressurized-gas hose may have one or more quick-action fasteners. Other types of pressure connection between the pressure connector and other constituent parts of the pressure-applying appliance are also possible.

As stated above, the cleaning appliance may in particular comprise a single-chamber washer or may be designed entirely or partially as a single-chamber washer. The single-chamber washer may in particular have at least one fluid tank which is formed separately from the cleaning chamber, in particular a rinsing tank, wherein, in the fluid tank, at least one cleaning fluid can be conditioned, in particular warmed, independently of a cleaning process taking place in the cleaning appliance.

The cleaning appliance may in particular be configured to carry out a cleaning program with at least two different program steps. Accordingly, the cleaning appliance may in particular be designed entirely or partially as an automatic programmed unit.

The cleaning appliance may be advantageously further developed in various ways. For example, as stated above, the pressure connector may comprise at least one positively locking and/or non-positively locking connecting element in order to additionally produce a mechanical connection to the breathing apparatus. This may involve in particular a quick-action coupling system and/or a thread. Alternatively or in addition, other mechanical connecting elements may also be used.

As stated above, the cleaning fluid may in particular comprise at least one aqueous cleaning fluid, that is to say water or water with one or more additives added, which additives may be present in dissolved form, in the form of an emulsion, or else in the form of a suspension. Alternatively or in addition, the cleaning fluid may also comprise at least one cleaner solution. A cleaner solution is to be understood here generally to mean a solution of at least one surfactant in at least one solvent, for example likewise water. For example, this may be a commercial cleaner solution which can also be used for dishwashers and/or which can be used in washing machines. Special cleaner solutions may however basically also be developed and/or used. Further alternatively or in addition, the cleaning fluid may also comprise a cleaning fluid with at least one rinsing aid, that is to say an additive which facilitates drying of the breathing apparatus and/or makes it easier for liquid to roll off at least one surface of the breathing apparatus. Such rinsing aids, which may likewise comprise one or more surfactants, are basically known from the field of dishwasher technology. Further alternatively or in addition, the cleaning fluid may also comprise at least one rinsing fluid, which may for example basically be water and/or water with one or more additives. Further alternatively or in addition, the cleaning fluid may also comprise a cleaning fluid with at least one disinfection agent, wherein a disinfection agent may basically be understood to mean any substance which has a germicidal action. Such disinfection agents are likewise basically known from the prior art. Further alternatively or in addition, the cleaning fluid may also comprise demineralized water. As will be discussed in more detail further below, the demineralized water may for example be provided in a corresponding demineralization device of the cleaning appliance, for example an ion exchanger. Alternatively or in addition, the demineralization device may however also comprise, for example, a reverse osmosis device. Further alternatively or in addition, the cleaning fluid may also comprise a warmed cleaning fluid. Such warmed cleaning fluids may be suitable in particular for rinsing, wherein warmed cleaning fluids are basically to be understood to mean cleaning fluids which are at a temperature of at least 25° C. Temperatures of 30° C. to 70° C. and in particular of 60° C. are particularly preferred. These temperatures have proven to be suitable in particular for cleaning flexible elastomer materials such as are commonly used for breathing apparatus.

As presented above, it is in particular possible for commercially available laundry washing machines and/or dishwashers, for example industrial laundry washing machines and/or industrial dishwashers, to be modified for the purposes of the present invention. This modification may be performed such that the laundry washing machines or dishwashers are equipped with a pressure-applying appliance according to the features described above. The cleaning appliance may for example be designed as a front-loader washer or as a hood-type washer. Here, a front-loader washer is to be understood to mean a washer with a cleaning chamber which can be opened by means of a flap and/or a slide by a user situated in front of the washer. A hood-type washer is to be understood here to mean a washer whose cleaning chamber comprises a hood which can be pivoted up and/or slid up and which can be separated from other constituent parts of the cleaning chamber, for example a base. Such hood-type washers are basically known from the field of industrial dishwasher technology. The cleaning chamber may in particular be of rigid design. The cleaning chamber may generally be designed such that it can be locked during the cleaning process, in particular by virtue of an automatic locking means being provided which is preferably triggered during a program and can be automatically released again after a program. Owing to the particular compact form, front-loader washers in particular are expedient in the context of the mobile cleaning unit proposed.

In a further aspect, the use of the proposed mobile cleaning unit in one or more of the described embodiments for cleaning at least one breathing apparatus is proposed. The breathing apparatus may be selected in particular from the following group: a breathing regulator for divers; a respiratory mask for divers; a breathing regulator for emergency services, in particular fire departments; a respiratory protection mask for emergency services; a compressed-air breathing appliance; a breathing regulator for police; a breathing regulator for armed forces; a respiratory mask for police; a respiratory mask for armed forces; a breathing regulator for medical purposes; a respiratory mask for medical purposes.

In a further aspect, a method for cleaning a breathing apparatus, for example one or more of the breathing apparatus mentioned above, is proposed. The method comprises the use of the proposed mobile cleaning unit in one or more of the described embodiments. Here, it is preferably the case that the at least one cleaning fluid is applied to the breathing apparatus, wherein it is preferable for at least one gas-conducting element of the breathing apparatus to be charged with the pressurized gas during the application of the cleaning fluid.

The proposed mobile cleaning unit and the proposed method have numerous advantages in relation to known appliances and methods of the stated type. In particular, the mobile cleaning unit may be designed in the form of a mobile washer for mobile dishwashing. The cleaning appliance may for example be accommodated, preferably together with other functional assemblies, on a trolley, in particular a roller container and/or a handcart, in particular a handcart with a dead mans brake. Aside from the pressurized-gas source, these further functional assemblies may for example include one or more of the following functional assemblies: a fresh water connector; a waste water connector; a water treatment system for feeding the washer, for example an ion exchanger and/or a reverse osmosis system; a hand wash basin, preferably with an extendable shower; a cabinet part for storing cleaning chemicals and other accessories; a work surface; a power unit, for example with a voltage of 400 V; a waste water lifting system; a fresh water tank; a waste water tank; an air compressor for blow-drying and/or pre-drying the cleaned articles. Combinations of the stated assemblies and/or of other components described above can also be integrated in an easy and straightforward manner.

The scope of the mobile cleaning unit may be freely designed and combined in accordance with requirements. The mobile cleaning unit may be designed so as to fit with existing systems for example in firefighting vehicles and such that it can be used there in an interchangeable manner with other mobile equipment carriers or articles of equipment, for example in implement trucks or in roller containers of the firefighting vehicles.

The entire mobile cleaning unit can both be connected to connectors on site, for example in order to realize temporary transition solutions, and be operated entirely autonomously, depending on equipment. In this way, with the mobile cleaning unit, it is possible for a temporary respiratory protection workshop, with preparation of the contaminated parts of personal protective equipment by machine, to be set up directly at the deployment location.

A corresponding mobile cleaning unit can be offered in standardized form in an extremely small space. In this way, independence from fixed building facilities can be ensured. Preparation of the parts of personal protective equipment by machine is thus also possible on site without additional outlay for transport of the contaminated parts.

The mobile cleaning unit can particularly advantageously be used in the case of relatively long-duration deployments involving large numbers of personnel and/or in the case of deployments in remote areas such as for example in the case of large deployments in rural regions or in the case of forest fires. The mobile cleaning unit can also be used advantageously in the case of military deployments or firefighting deployments in undeveloped areas. The mobile cleaning unit can be provided with extensive additional equipment and may optionally even be designed such that it can be operated entirely autonomously and without external provision of energy and media such as, for example, water.

In summary, and without limitation of further possible embodiments, the following embodiments are proposed:

Embodiment 1: A mobile cleaning unit for cleaning breathing apparatus, comprising:
at least one trolley with at least one support surface and with at least one running gear;
at least one pressurized-gas source mounted on the trolley; and
at least one cleaning appliance which is mounted on the trolley and which serves for the cleaning of the breathing apparatus, wherein the cleaning appliance comprises:
   at least one cleaning chamber for accommodating at least one breathing apparatus,
   at least one fluid device for applying at least one cleaning liquid to the breathing apparatus, wherein the fluid device has at least one nozzle,
   at least one holder which can be introduced into the cleaning chamber and which serves for accommodating the breathing apparatus, wherein the holder is configured to orient the breathing apparatus relative to the fluid device,
   at least one pressure-applying appliance which is connectable to the pressurized-gas source and which has at least one pressure connector, wherein the pressure connector is connectable to at least one gas-conducting element of the breathing apparatus, wherein the pressure-applying appliance is configured to charge the gas-conducting element with pressurized gas while the cleaning fluid is applied to the breathing apparatus.

Embodiment 2: The mobile cleaning unit according to the preceding embodiment, wherein the trolley has at least one push frame with at least one handle, in particular with a push bar.

Embodiment 3: The mobile cleaning unit according to the preceding embodiment, wherein the handle is equipped with a brake.

Embodiment 4: The mobile cleaning unit according to either of the two preceding embodiments, wherein the handle has at least one dead man's brake.

Embodiment 5: The mobile cleaning unit according to any one of the preceding embodiments, wherein the mobile cleaning unit furthermore has at least one pressurized-gas pistol which is connectable to the pressurized-gas source and which serves for blow-drying the breathing apparatus.

Embodiment 6: The mobile cleaning unit according to any one of the preceding embodiments, wherein the pressurized-gas source comprises at least one element selected from the following group: a pressurized-gas bottle; a compressor; a pressurized-gas fitting for the connection of an external pressure source.

Embodiment 7: The mobile cleaning unit according to any one of the preceding embodiments, wherein the pressurized-gas source is detachably mounted on the trolley.

Embodiment 8: The mobile cleaning unit according to any one of the preceding embodiments, furthermore comprising at least one waste water tank mounted on the trolley, wherein the waste water tank is connectable to at least one drain of the cleaning appliance.

Embodiment 9: The mobile cleaning unit according to any one of the preceding embodiments, furthermore comprising at least one fresh water treatment system which is mounted on the trolley and which serves for the treatment of fresh water, wherein the fresh water treatment system is connectable to at least one feed of the cleaning appliance.

Embodiment 10: The mobile cleaning unit according to the preceding embodiment, wherein the fresh water treatment system comprises at least one appliance selected from the following group: a reverse osmosis system; an ion exchanger; a fresh water filter.

Embodiment 11: The mobile cleaning unit according to any one of the preceding embodiments, furthermore comprising at least one waste water treatment system mounted on the trolley, wherein the waste water treatment system is connected to at least one drain of the cleaning appliance.

Embodiment 12: The mobile cleaning unit according to any one of the preceding embodiments, furthermore comprising at least one fresh water tank mounted on the trolley, wherein the fresh water tank is connectable to at least one feed of the cleaning appliance.

Embodiment 13: The mobile cleaning unit according to any one of the preceding embodiments, furthermore comprising at least one cabinet element which is mounted on the trolley and which serves for accommodating cleaning utensils.

Embodiment 14: The mobile cleaning unit according to any one of the preceding embodiments, furthermore comprising at least one work surface mounted on the trolley.

Embodiment 15: The mobile cleaning unit according to any one of the preceding embodiments, furthermore comprising at least one power unit mounted on the trolley.

Embodiment 16: The mobile cleaning unit according to any one of the preceding embodiments, furthermore comprising a waste water lifting system mounted on the trolley.

Embodiment 17: The mobile cleaning unit according to any one of the preceding embodiments, furthermore comprising at least one fresh water connector mounted on the trolley, wherein the fresh water connector is connected to at least one feed of the cleaning appliance and wherein the fresh water connector is connectable to at least one external fresh water feed.

Embodiment 18: The mobile cleaning unit according to any one of the preceding embodiments, furthermore comprising at least one waste water connector mounted on the trolley, wherein the waste water connector is connected to at least one drain of the cleaning appliance and wherein the drain is designed to be connectable to an external drain.

Embodiment 19: The mobile cleaning unit according to any one of the preceding embodiments, furthermore comprising at least one washbasin mounted on the trolley.

Embodiment 20: The mobile cleaning unit according to any one of the preceding embodiments, furthermore comprising at least one hand shower mounted on the trolley, in particular an extendable hand shower.

Embodiment 21: The mobile cleaning unit according to any one of the preceding embodiments, wherein the trolley has a basic dimension of a standardized transport pallet, in particular a basic dimension selected from: 800 mm×600 mm; 1200 mm×800 mm; 1200 mm×1000 mm; 1200 mm×900 mm; 1140 mm×1140 mm.

Embodiment 22: The mobile cleaning unit according to any one of the preceding embodiments, wherein the application of the at least one cleaning liquid to the breathing apparatus is performed in the form of a direct application, wherein cleaning fluid emerging from the fluid device impinges directly on the breathing apparatus, wherein the application is selected from application in spray form, application in droplet form, application in jet form or a combination of the stated types of application.

Embodiment 23: The mobile cleaning unit according to any one of the preceding embodiments, wherein the pressure connector comprises at least one connecting element in order to additionally produce a mechanical connection to the breathing apparatus, wherein the connecting element is selected from the group comprising a positively locking connecting element and a non-positively locking connecting element.

Embodiment 24: The mobile cleaning unit according to any one of the preceding embodiments, wherein the pressure connector has a multiplicity of different adapters for connection to different types of gas-conducting elements.

Embodiment 25: The mobile cleaning unit according to any one of the preceding embodiments, wherein the holder is a removable holder.

Embodiment 26: The mobile cleaning unit according to any one of the preceding embodiments, wherein the pressure connector is at least partially integrated into the holder.

Embodiment 27: The mobile cleaning unit according to any one of the preceding embodiments, wherein the holder has a detachable pressurized-gas connection to the rest of the cleaning appliance.

Embodiment 28: The mobile cleaning unit according to any one of the preceding embodiments, wherein the cleaning appliance comprises a single-chamber washer, wherein the single-chamber washer has at least one fluid tank which is formed separately from the cleaning chamber, wherein, in the fluid tank, at least one cleaning fluid can be conditioned, in particular warmed, independently of a cleaning process taking place in the cleaning appliance.

Embodiment 29: The mobile cleaning unit according to any one of the preceding embodiments, wherein the cleaning appliance is configured to carry out a cleaning program with at least two different program steps.

Embodiment 30: The use of the mobile cleaning unit according to any one of the preceding embodiments for cleaning at least one breathing apparatus.

Embodiment 31: The use according to the preceding embodiment, wherein the breathing apparatus is selected from the following group: a breathing regulator for divers; a respiratory mask for divers; a breathing regulator for emergency services, in particular fire departments; a respiratory protection mask for emergency services; a compressed-air breathing appliance; a breathing regulator for police; a breathing regulator for armed forces; a respiratory mask for police; a respiratory mask for armed forces; a breathing regulator for medical purposes; a respiratory mask for medical purposes.

Embodiment 32: A method for cleaning a breathing apparatus, comprising the use of a mobile cleaning unit according to any one of the preceding embodiments relating to a mobile cleaning unit.

Embodiment 33: The method according to the preceding embodiment, wherein at least one cleaning fluid is applied to the breathing apparatus, wherein at least one gas-conducting element of the breathing apparatus is charged with a pressurized gas during the application of the cleaning fluid.

### BRIEF DESCRIPTION OF THE FIGURES

Further details and features will emerge from the following description of exemplary embodiments, in particular in conjunction with the subclaims. Here, the respective features may be realized individually or collectively in combination with one another. The invention is not restricted to the exemplary embodiments. The exemplary embodiments are illustrated schematically in the figures. Identical reference designations in the individual figures denote identical or functionally identical elements or elements which correspond to one another in terms of their functions.

Specifically, in the figures:

FIG. 1 shows a sectional illustration of a cleaning appliance for use in a mobile cleaning unit;

FIG. 2 shows a detail illustration of a populated holder of the cleaning appliance as per FIG. 1;

FIGS. 3A and 3B show a trolley for use in the mobile cleaning unit in a rear view (FIG. 3A) and in a side view (FIG. 3B);

FIG. 3C shows a roller container for use by fire departments, with a multiplicity of trolleys according to FIGS. 3A and 3B; and

FIG. 4 shows an exemplary embodiment of a mobile cleaning unit for cleaning breathing apparatus.

### DESCRIPTION OF THE EXEMPLARY EMBODIMENTS

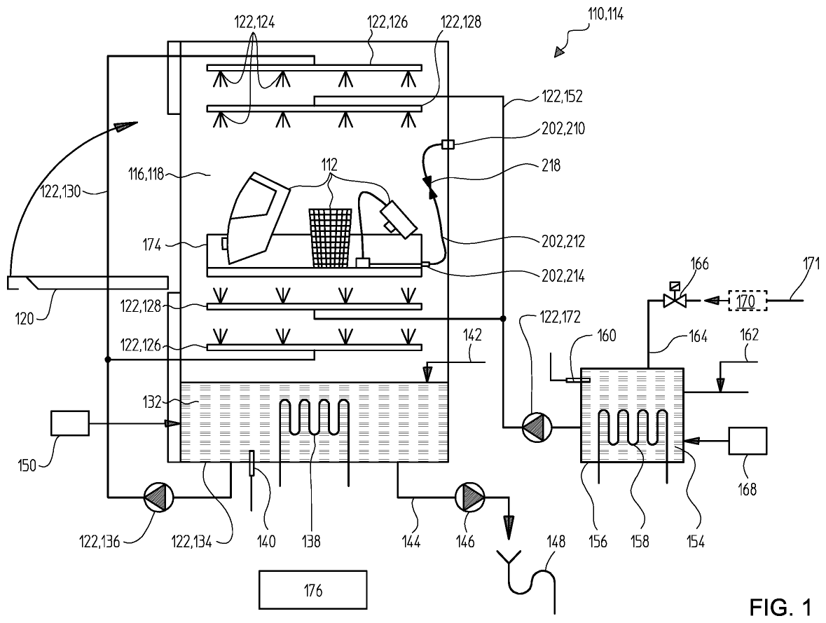

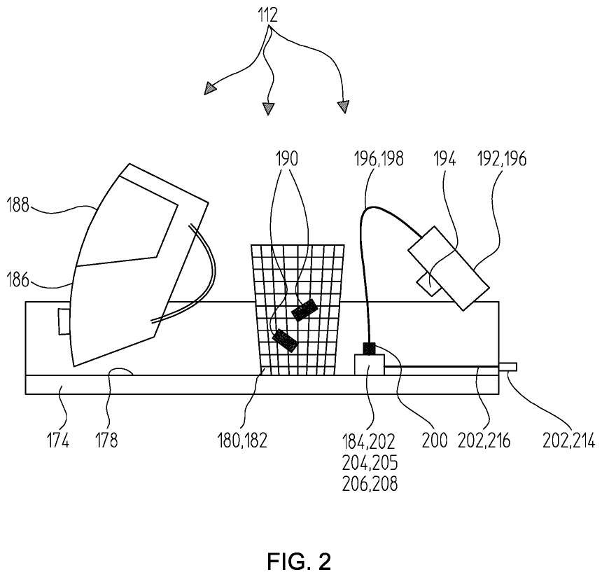

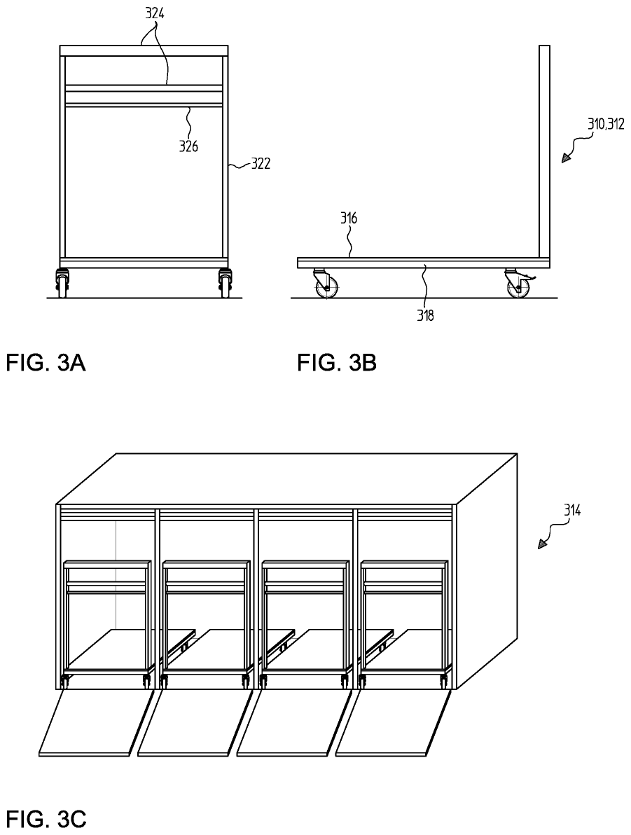

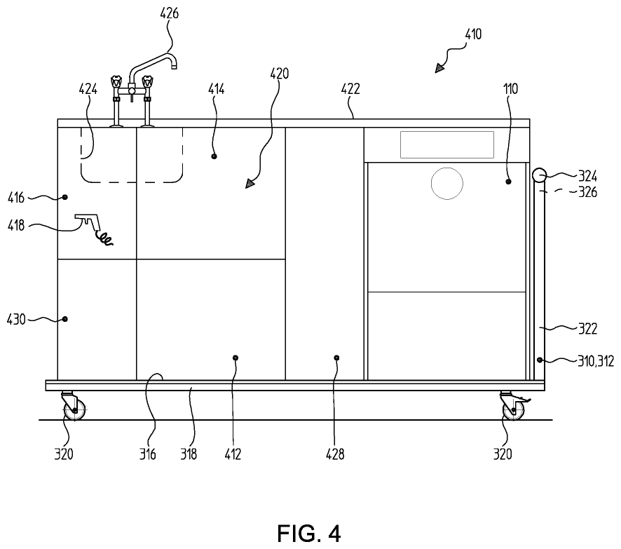

FIGS. 1-3 illustrate various components of an exemplary embodiment of a mobile cleaning unit 410, an exemplary embodiment of which is shown in its entirety in a side view in FIG. 4. Here, FIGS. 1 and 2 show a cleaning appliance 110. FIGS. 3A and 3B show a trolley 310 in the form of a roller trolley 312 in a rear view (FIG. 3A) and in a side view (FIG. 3B). FIG. 3C shows a multiplicity of trolleys 310 as per FIGS. 3A and 3B in a roller container 314 for use by fire departments, in a perspective illustration. Finally, FIG. 4 shows the mobile cleaning unit 410 populated with the various components in a side view. These figures will be discussed collectively below.

The mobile cleaning unit 410 illustrated in a side view in FIG. 4 comprises a trolley 310, which is illustrated in FIGS. 3A and 3B and which, in this exemplary embodiment, is designed by way of example as a roller trolley 312, or comprises a roller trolley 312 of said type. For example, it may be a standardized roller container which, in terms of basic dimension and preferably also of other dimensions, can be accommodated in a firefighting vehicle, an implement truck or, as illustrated in FIG. 3C, a roller container 314 for firefighting deployments. The trolley 310 comprises at least one support surface 316, for example in the form of a surface of a base plate 318, and a running gear 320. Furthermore, the trolley 310 may have at least one handle 324 and preferably at least one brake 326, for example a dead man's brake. As a possible exemplary embodiment of a trolley 310 of said type, reference may be made for example to universal roller containers from Gunzburger Steigtechnik GmbH, 89312 Gunzburg, Germany. Other trolleys, roller trolleys or roller containers may however also basically be used. In particular, use may also be made of entirely or partially closed roller containers.

As will be discussed in more detail further below, various elements of the mobile cleaning unit 410 are fixedly or detachably mounted on the trolley 310. In particular, as can be seen in FIG. 4, the mobile cleaning unit 110 comprises at least one cleaning appliance 110 and at least one pressurized-gas source 416. Further details will be described in more detail further below.

FIG. 1 illustrates an exemplary embodiment of the cleaning appliance 110, which is configured for cleaning one or more breathing apparatus 112 and which can be used in the mobile cleaning unit 410, for example as per FIG. 4. The cleaning appliance 110 is shown schematically in a sectional illustration in FIG. 1. The cleaning appliance 110 may be designed for example as a washer 114, wherein it is for example possible for industrial dishwashers to be correspondingly modified, for example under-counter washers from Meiko Maschinenbau GmbH & Co. KG, 77652, Offenburg. The cleaning appliance 110 comprises a cleaning chamber 116, for example a washing chamber 118. Said cleaning chamber 116 can for example be opened by means of a door 120, for example a pivoting door, a sliding door or a flap, and/or by means of some other opening appliance. Alternatively or in addition, the cleaning chamber 116 may also be designed as a cleaning chamber covered by means of a hood. In the exemplary embodiment illustrated in FIG. 1, the washer 114 is designed for example as a front-loader washer. Other embodiments are however also possible.

The cleaning appliance 110 has at least one fluid device 122 for applying one or more cleaning fluids to the breathing apparatus 112 accommodated in the cleaning chamber 116. For example, the fluid device 122 may comprise one or more nozzles 124 which may be arranged for example above and/or below the breathing apparatus 112 and/or at other locations within the cleaning chamber 116, for example on one or more side walls. For example, the fluid device 122 may, as in the illustrated exemplary embodiment as per FIG. 1, comprise a washing nozzle system 126, also referred to as wash nozzle system, for example with one or more nozzle arms which are accommodated below and/or above the breathing apparatus 112 and which are preferably mounted in a rotatable and/or pivotable manner and which have multiple nozzles 124. Alternatively or in addition, the fluid device 122 may also comprise a rinsing nozzle system 128, for example with one or more rinsing nozzle arms, which are preferably in turn mounted so as to be rotatable and/or pivotable and which may for example in turn be arranged above and/or below the breathing apparatus 112. Other arrangements and/or configurations are however basically also possible.

The fluid device 122 may furthermore comprise one or more further elements such as for example one or more pipelines, one or more pumps and/or one or more tanks. For example, in the exemplary embodiment illustrated, at least one washing line system 130 is thus provided for charging the washing nozzle system 126 with cleaning fluid 132, for example cleaner solution, from one or more washing tanks 134. For example, a washing tank 134 may be provided in the base region of the cleaning chamber 116, and/or connected in some other way to the cleaning chamber 116, such that cleaning fluid 132, after being applied to the breathing apparatus 112, can flow and/or drip back into the washing tank 134. For the charging of the washing nozzle system 126 with the cleaning fluid 132 from the washing tank 134, the fluid device 122 may furthermore have one or more circulating pumps 136. Furthermore, one or more heating elements 138 may be provided for warming the cleaning fluid 132 of the washing tank 134 and/or of other tanks, for example in the form of a washing tank heater within the washing tank 134. To monitor the heating of the cleaning fluid 132, one or more temperature sensors 140 may be provided, for example within the washing tank 134. Furthermore, one or more level sensors 142 may be provided, for example one level sensor 142 as a level sensor of the washing tank 134.

The washing tank 134 may for example be capable of being emptied via a discharge line 144 and optionally via a discharge pump 146 into a drain 148. The drain 148 may for example be connected to a waste water tank 412 of the mobile cleaning unit 410, which waste water tank is illustrated for example in FIG. 4 and is accommodated for example on the trolley 310. Alternatively or in addition, discharging into an on-site drain is also possible. Both possibilities may also be used in combination, including the option of switching between the two possibilities, for example if a waste water tank has reached its capacity limit. Furthermore, the mobile cleaning unit 410 may, as stated above, have a waste water lifting system (not illustrated here), for example for compensating differences in waste water level. In this regard, reference may for example be made to lifting systems from SFA Sanibroy GmbH, 63128 Dietzenbach, Germany.

It is optionally also possible for one or more feeds (not illustrated in FIG. 1) to the washing tank 134 to be provided in order to fill the latter with cleaning fluid 132. Said feeds may optionally be connected to an on-site supply and/or connected to a fresh water tank 414, which is shown for example in FIG. 4. Alternatively or in addition, filling may however also be realized via the rinsing nozzle system 128 that will be described in more detail below, for example via a fresh water feed 171. The fresh water feed 171 may for example be connected to a fresh water tank 414 of the mobile cleaning unit 410, optionally via the reverse osmosis device 170 that will be described in more detail further below.

Furthermore, a dosing system 150 may be provided, for example at least one dosing system for introducing one or more additives, for example a cleaner concentrate, a rinsing aid, a disinfection agent or combinations of these and/or other additives, into the cleaning fluid 132 of the washing tank 134. Storage vessels for the dosing system 150 may for example likewise be accommodated on the trolley 310.

The cleaning fluid 132 may in particular be applied to the breathing apparatus 112 in a circulation operating mode by virtue of the cleaning fluid 132 from the washing tank 134 being sprayed onto the breathing apparatus 112 by means of the wash nozzle system or washing nozzle system 126, before then running off or dripping off back into the washing tank 134 in order to be reused from there. It is optionally possible for one or more filters, for example coarse filters and/or fine filters, to be provided in order to at least partially purify the cleaning fluid 132 of the washing tank 134.

The rinsing nozzle system 128 may be charged with a further cleaning fluid 154, for example a rinsing liquid, for example via at least one rinsing line system 152. Here, FIG. 1 shows an optional embodiment in which the cleaning appliance 110 is designed as a two-circuit system. Accordingly, the second cleaning fluid 154 is provided for example from a separate tank, which in the exemplary embodiment illustrated is designed as a rinsing tank 156, which is formed separately from the washing tank 134. For example, said rinsing tank 156 may be in the form of a boiler, and may for example comprise a rinsing tank heater 158. Alternatively or in addition to a rinsing tank heater 158, it is also possible for other types of heating elements, for example one or more flow heaters, to be provided for the second cleaning fluid 154. The same also applies to the first cleaning fluid 132 in the washing tank 134. It is in turn possible for one or more temperature sensors 160 and/or one or more level sensors 162 to be provided in the rinsing tank 156, and the rinsing tank 156 may be fed with cleaning fluid 154, for example fresh water, via one or more feeds 164. The at least one feed 164 may have one or more valves 166. For example, the feed 164 may be connected or connectable via the fresh water feed 171 to an on-site fresh water connector, or may optionally be connected directly or indirectly to the fresh water tank 414, as stated above. A combination of the stated possibilities, including the option of switching between the two options, may also be realized. Alternatively or in addition, it is possible for at least one reverse osmosis device 170 to be provided on-site, as a constituent part of the cleaning appliance 110 or as a constituent part of the mobile cleaning unit 410, by means of which at least one reverse osmosis device the rinsing tank 156 and/or one or more other tanks of the cleaning appliance 110 can be charged with a permeate, for example purified water. Furthermore, it is in turn possible for at least one dosing system 168 to be provided, by means of which one or more additives, for example one or more rinsing aid concentrates, can be admixed to the cleaning fluid 154 in the rinsing tank 156.

The charging of the rinsing nozzle system 128 may preferably be performed in a single operating mode, that is to say not in a circulation operating mode, such that the rinsing fluid from the rinsing tank 154 is applied to the breathing apparatus 112 only once. For the application, the fluid device 122 may for example comprise one or more pressure-increasing pumps 172.

The cleaning of the breathing apparatus 112 in the cleaning appliance 110 as per FIG. 1 may for example be performed by virtue of firstly one or more breathing apparatus 112 being introduced into the cleaning chamber 116 by means of a suitable holder 174, which will be discussed in more detail further below. Subsequently, the door 120 can be closed, and it is preferably possible for a cleaning program to be started which can be controlled for example by means of a controller 176, for example a central machine controller or a peripheral controller. Here, it is for example possible for firstly the washing tank 136 to be filled by means of the rinsing nozzle system 128 with cleaning fluid 132 and/or with a precursor of said cleaning fluid 132, for example fresh water, in particular demineralized fresh water. This may then be conditioned within the washing tank 134, for example by admixing of one or more additives via the nozzle system 150 and/or by warming by means of the heating element 138. Alternatively or in addition, the cleaning fluid 132 may also have remained in the washing tank 134 after a rinsing program of a preceding cleaning cycle in order to be utilized in a subsequent cleaning cycle as cleaning fluid 132 and/or as a constituent part thereof, because rinsing fluid generally has a relatively high degree of purity even after being applied to the breathing apparatus 112.

The breathing apparatus 112 may subsequently be cleaned, in particular washed, preferably in a circulation operating mode, in one or more washing program steps. Here, adherent contaminants can be removed from the breathing apparatus 112, and/or hygienization of the breathing apparatus 112 can be performed.

Following the at least one washing program step, it is preferably possible for one or more rinsing steps to be performed. For this purpose, the washing tank 134 may optionally be emptied via the discharge line 144 and the discharge pump 146. The rinsing tank 156 may already have been filled with the rinsing fluid 154, for example fresh water with or without additives, for example demineralized fresh water, during the at least one washing program step. It is subsequently possible for one or more additives to be admixed by means of the dosing system 150, and/or warming of the cleaning fluid 154 as rinsing fluid may be performed by means of the rinsing tank heater 158 and/or by means of a flow heater. The rinsing fluid 154 that has been preconditioned in this way can then, in the at least one rinsing step, be applied via the rinsing nozzle system 128 to the breathing apparatus 112, such that said breathing apparatus are rinsed. The at least one rinsing step may optionally in turn be followed by at least one drying step, which may be of passive form, by means of a simple waiting time, or which may also be actively assisted, for example by means of at least one drying fan and/or some other type of drying appliance of the cleaning appliance 110, for example an infrared radiator system and/or a microwave radiation system. Various embodiments are conceivable. Following the optional drying step, the door 120, which has optionally preferably been locked up until this point, can be automatically released and/or opened. The entire program sequence may for example be controlled by means of the controller 176, wherein it is also possible for multiple program sequences to be selectable.

It is pointed out that the exemplary embodiment of the cleaning appliance 110 illustrated in FIG. 1 represents only one of several different exemplary embodiments. For example, it is possible for individual or several or even all of the elements described above to also be implemented in a different scope. Alternatively or in addition to the rigid, positionally fixed embodiment as per FIG. 1, the washing chamber 118 may also be designed to be pivotable and/or rotatable. It is furthermore also possible for the illustrated fluid circuit to be considerably modified.

As illustrated above, the at least one breathing apparatus 112 is held within the cleaning appliance 110 preferably by means of at least one holder 174. Such a holder 174 is shown by way of example in an enlarged sectional illustration in FIG. 2. The holder 174 may be produced for example from plastic and/or metal, and may for example be designed as a basket, as shown in FIG. 2. The holder 174 may comprise one or more support surfaces 178 and/or one or more holding elements 180, for example one or more baskets 182 and/or one or more connecting elements 184 for a mechanical connection to the breathing apparatus 112 and/or for the fixing thereof. Accordingly, the holder 174 may for example be designed to orient and/or to fix one or more components of the breathing apparatus 112 relative to one or more of the nozzles 124. For example, the breathing apparatus 112 may for example comprise at least one respiratory mask 186, wherein the orientation by means of the support surface 178 may for example be performed such that a visor 188 always points toward the upper nozzle system, whereas the inner side of the respiratory mask 186 points downward, such that cleaning fluid 132, 154 entering via the lower nozzles can run off again after being applied, without residues remaining within the respiratory mask 186. The basket 182 may for example be configured to accommodate accessories 190, which may likewise be constituent parts of the breathing apparatus 112, for example in order to maintain an assignment to other components of the breathing apparatus 112 during the cleaning process. In this way, it is for example possible to ensure that different types of breathing apparatus 112 can be cleaned without incompatible accessory parts being mixed up. Furthermore, the breathing apparatus 112 may for example comprise one or more breathing regulators 192 and/or one or more stages of such breathing regulators 192. Breathing regulators 192 of said type generally comprise, in their interior, one or more valves 194, for example diaphragm and/or toggle valves, by means of which one or more gas-conducting elements 196 are separated from an exterior space. For example, gas-conducting elements 196 may be provided in the interior of one or more gas lines 198 of the breathing regulator 192, wherein the inner walls of the gas line 198 generally must not come into contact with cleaning fluid 132, 154. The gas line 198 may for example end in one or more connectors 200, for example in one or more quick-action couplings.

In order to prevent the at least one gas-conducting element 196 of the breathing apparatus 112, for example the gas line 198 of the breathing regulator 192, from coming into contact with cleaning fluid 132, 154, provision is made for said gas-conducting element 196 to be charged with pressurized gas, for example during one or more program steps in which the cleaning fluid 132, 154 is applied to the breathing apparatus 112. For this purpose, the cleaning appliance 110 in this exemplary embodiment, or also in other exemplary embodiments, has at least one pressure-applying appliance 202. Said pressure-applying appliance 202 is configured to charge the at least one gas-conducting element 196 with pressurized gas. For this purpose, the pressure-applying appliance 202 has at least one pressure connector 204, which is connectable to the gas-conducting element 196 such that such charging with gas can be performed. In the exemplary embodiment illustrated, said pressure connector 204 is formed for example as a constituent part of the holder 174. Alternatively or in addition, however, the pressure connector 204 may also be provided at other locations in the cleaning appliance 110, preferably in the interior of the cleaning chamber 116. In the exemplary embodiment illustrated, the pressure connector 204 may for example be designed as a connector 206 for the breathing regulator 192. In this exemplary embodiment or also in other exemplary embodiments, the pressure connector 204 may in this case be generally designed such that it can be connected to several types of gas-conducting elements 196, for example to different types and/or different forms of gas-conducting elements 196. For example, the pressure connector 204 may comprise a multiplicity of adapters 205, and/or the cleaning appliance 110 may be supplied with an adapter set with multiple adapters 205 of different pressure connectors 204, such that there is a high level of flexibility with regard to the type of the gas-conducting elements 196. For example, the connector 206 may comprise, for the breathing regulator 192, a quick-action coupling which corresponds to the connector 200 of the gas line 198 and which is preferably connectable in pressure-tight fashion thereto. In this or also in other cases, the pressure connector 204 may thus also comprise at least one connecting element 208 and/or be designed as a connecting element 208 for producing a mechanical connection to the breathing apparatus 112 and in particular to the gas-conducting element 196.

For the charging of the pressure connector 204 and of the gas-conducting element 196 with pressurized gas, for example pressurized air, the cleaning appliance 110 and/or the mobile cleaning unit 410 may, in the exemplary embodiment illustrated or also in other embodiments, comprise at least one internal and/or at least one external pressurized-gas source 416, as shown in FIG. 4. For example, a pressurized-gas source 416 may be arranged on the trolley 310. Said pressurized-gas source 416 may for example comprise at least one compressor and/or at least one pressurized-gas bottle. Alternatively or in addition, the cleaning appliance 110 may also, as illustrated in FIG. 1, be equipped, by way of at least one external pressure connector 210, for being connected by way of said external pressure connector 210 to at least one external pressurized-gas source, for example an external pressurized-gas bottle and/or an external pressurized-gas line, which may be provided for example on site or on an implement truck or other firefighting vehicles. The external pressure connector 210 and/or the internal pressurized-gas source 416 may for example be connected via at least one pressurized-gas line 212 to the pressure connector 204. If the pressure connector 204 has been connected to a holder 174, as illustrated in FIGS. 1 and 2, then the pressurized-gas line 212 can for example be detachably connected to the holder 174 and/or to the pressure connector 204 in order to optionally permit a reversible removal of the holder 174 from the cleaning appliance 110. For example, for this purpose, one or more couplings 214 may be provided, which may for example in turn be connected via one or more pressurized-gas lines 216 to the pressure connector 204. It is also possible for a distributor system to be provided within or outside the holder 174, for example in order to be able to charge a multiplicity of pressure connectors 204 with pressurized gas by means of one pressurized-gas line 212. It is in turn also possible for one or more adapters 205 to be provided, for example in order to permit an adaptation to a multiplicity of different types of gas-conducting elements 196 and/or breathing apparatus 112. The pressure-applying appliance 202 may be designed to be separable at one or more points, for example in order to make it possible for the holder 174 to be removed from the cleaning chamber 116 and, for example, populated. For this purpose, the coupling 214 may for example be designed to be releasable. Furthermore, in this exemplary embodiment or also in other exemplary embodiments of the cleaning appliance 110, the pressure-applying appliance 202 may optionally comprise one or more valves 218, for example controllable valves, for example (as illustrated in FIG. 1) in the pressurized-gas line 212 and/or in or upstream of the external pressure connector 210. Said valves 218 may for example be controlled by the controller 176. It is thus possible, for example in this way or also in some other way, for the application of pressure to the at least one gas-conducting element 196 by means of the pressure-applying appliance 202 to be performed in controlled fashion in this exemplary embodiment or also in other exemplary embodiments of the invention, for example by virtue of the application of pressure being performed in targeted fashion prior to the commencement of an application of cleaning fluid 132, 154 to the breathing apparatus 112. Alternatively or in addition, the application of pressure may also be performed only in one or more program steps, for example only in one or more program steps during an application of cleaning fluid 132, 154 to the breathing apparatus 112. Optionally, the charging with pressurized gas, for example compressed air, may, by contrast, be deactivated and/or performed in some other form, for example with changed pressure, during other program steps. In this way, the application of pressure can for example be adapted to the various program steps.

The mobile cleaning unit 410 shown in FIG. 4 may comprise further elements aside from the elements mentioned above. In particular, the mobile cleaning unit may have at least one pressurized-gas pistol 418 connected to the pressurized-gas source 416. Furthermore, it is for example possible for a cabinet element 420 and/or a work surface 422 to be provided. Furthermore, on the trolley 310, there may for example be provided a washbasin 424, preferably with at least one hand shower 426, which may for example be designed as an extendable hand shower.

It is for example possible for cleaning agents 428 and/or other utensils to be stored in the cabinet element 420. Furthermore, it is possible for one or more of the abovementioned elements of the mobile cleaning unit 410 to be accommodated entirely or partially in the cabinet element 420. Furthermore, the mobile cleaning unit 410 may comprise at least one energy source, for example at least one power unit 430.

### LIST OF REFERENCE DESIGNATIONS

110 Cleaning appliance
112 Breathing apparatus
114 Washer
116 Cleaning chamber
118 Washing chamber
120 Door
122 Fluid device
124 Nozzles
126 Washing nozzle system
128 Rinsing nozzle system
130 Washing line system
132 Cleaning fluid, washing fluid
134 Washing tank
136 Circulating pump
138 Heating element
140 Temperature sensor
142 Level sensor
144 Discharge line
146 Discharge pump
148 Drain
150 Dosing system
152 Rinsing line system
154 Cleaning fluid, rinsing fluid
156 Rinsing tank
158 Rinsing tank heater
160 Temperature sensor
162 Level sensor
164 Feed
166 Valve
168 Dosing system
170 Reverse osmosis device
171 Fresh water feed
172 Pressure-increasing pump
174 Holder
176 Controller
178 Support surface
180 Holding element
182 Basket
184 Connecting element
186 Respiratory mask
188 Visor
190 Accessory
192 Breathing regulator
194 Valve
196 Gas-conducting element
198 Gas line
200 Connector
202 Pressure-applying appliance
204 Pressure connector
205 Adapter
206 Connector for breathing regulator
208 Connecting element
209 Integrated pressurized-gas source
210 External pressure connector
212 Pressurized-gas line
214 Coupling
216 Pressurized-gas line
218 Valves
310 Trolley
312 Roller trolley
314 Rolling container
316 Support surface
318 Base plate
320 Running gear
322 Push frame
324 Handle
326 Brake
410 Mobile cleaning unit
412 Waste water tank
414 Fresh water tank
416 Pressurized-gas source
418 Pressurized-gas pistol
420 Cabinet element
422 Work surface
424 Washbasin
426 Hand shower
428 Cleaning agent
430 Power unit

1. A mobile cleaning unit for cleaning breathing apparatus, comprising:
at least one trolley with at least one support surface and with at least one running gear;
at least one pressurized-gas source mounted on the trolley; and
at least one cleaning appliance which is mounted on the trolley and which serves for the cleaning of the breathing apparatus, wherein the cleaning appliance comprises:
at least one cleaning chamber for accommodating at least one breathing apparatus,
at least one fluid device for applying at least one cleaning liquid to the breathing apparatus, wherein the fluid device has at least one nozzle,
at least one holder which can be introduced into the cleaning chamber and which serves for accommodating the breathing apparatus, wherein the holder is configured to orient the breathing apparatus relative to the fluid device,
at least one pressure-applying appliance which is connectable to the pressurized-gas source and which has at least one pressure connector, wherein the pressure connector is connectable to at least one gas-conducting element of the breathing apparatus, wherein the pressure-applying appliance is configured to charge the gas-conducting element with pressurized gas while the cleaning fluid is applied to the breathing apparatus.

2. The mobile cleaning unit as claimed in the preceding claim 1, wherein the trolley has at least one push frame with at least one handle.

3. The mobile cleaning unit as claimed in claim 2, wherein the handle is equipped with a brake.

4. The mobile cleaning unit as claimed in claim 1, wherein the mobile cleaning unit furthermore has at least one pressurized-gas pistol which is connectable to the pressurized-gas source and which serves for blow-drying the breathing apparatus.

5. The mobile cleaning unit as claimed in claim 1, furthermore comprising at least one element selected from the following group:
at least one waste water tank mounted on the trolley, wherein the waste water tank is connectable to at least one drain of the cleaning appliance;
at least one waste water treatment system mounted on the trolley, wherein the waste water treatment system is connected to at least one drain of the cleaning appliance;
at least one waste water lifting system mounted on the trolley;
at least one fresh water tank mounted on the trolley, wherein the fresh water tank is connectable to at least one feed of the cleaning appliance;
at least one fresh water treatment system which is mounted on the trolley and which serves for the treatment of fresh water, wherein the fresh water treatment system is connectable to at least one feed of the cleaning appliance.

6. The mobile cleaning unit as claimed in claim 1, furthermore comprising at least one cabinet element which is mounted on the trolley and which serves for accommodating cleaning utensils.

7. The mobile cleaning unit as claimed claim 1, furthermore comprising at least one work surface mounted on the trolley.

8. The mobile cleaning unit as claimed in claim 1, furthermore comprising at least one power unit mounted on the trolley.

9. The mobile cleaning unit as claimed claim 1, furthermore comprising at least one washbasin mounted on the trolley.

10. The mobile cleaning unit as claimed in claim 1, furthermore comprising at least one hand shower mounted on the trolley.

11. The mobile cleaning unit as claimed in claim 1, wherein the trolley has a basic dimension of a standardized transport pallet.

12. The mobile cleaning unit as claimed in claim 1, wherein the application of the at least one cleaning liquid to the breathing apparatus is performed in the form of a direct application, wherein cleaning fluid emerging from the fluid device impinges directly on the breathing apparatus, wherein the application is selected from application in spray form, application in droplet form, application in jet form or a combination of the stated types of application.

13. The mobile cleaning unit as claimed in claim 1, wherein the pressure connector has a multiplicity of different adapters for connection to different types of gas-conducting elements.

14. The mobile cleaning unit as claimed in claim 1, wherein the pressure connector is at least partially integrated into the holder.

15. A method for cleaning a breathing apparatus, comprising the use of a mobile cleaning unit as claimed in claim 1.
